(19) United States
(12) Patent Application Publication
(10) Pub. No.: US 2021/0382529 A1
(43) Pub. Date: Dec. 9, 2021

(54) ACOUSTIC PANELS AND STRUCTURES INCLUDING THE SAME

(71) Applicant: 3M INNOVATIVE PROPERTIES COMPANY, St. Paul, MN (US)

(72) Inventors: Catherine A. Leatherdale, Woodbury, MN (US); James Michael Jonza, Lake Elmo, MN (US); Ronald Wayne Gerdes, St. Paul, MN (US); Thomas Herdtle, Inver Grove Heights, MN (US); Steven M. Jorro, Carmel, IN (US)

(21) Appl. No.: 17/284,916

(22) PCT Filed: Nov. 5, 2019
(86) PCT No.: PCT/IB2019/059507

§ 371 Date: Apr. 13, 2021

Related U.S. Application Data
(60) Provisional application No. 62/758,257, filed on Nov. 9, 2018.

(51) Int. Cl. G06F 1/18; G10K 11/168

(52) U.S. Cl. CPC G06F 1/182; G10K 11/168

(57) ABSTRACT

An acoustic absorbing panel adapted for use with computers and servers includes a first layer and an opposing second layer, and a core disposed between the first and second layers, the core including walls extending between the first and second layers and defining a series of cells, each cell being at least partially surrounded by a wall, adjacent cells being interconnected via an opening in the at least one wall. The panel includes a through hole in the first layer or the second layer. The hole may be aligned with a cell in a series of cells. The panel has an absorption band at a frequency between 800 Hz and 12000 Hz. The panel may include a flame resistant polymer composition. The panel may be mounted on the frame of an electronics enclosure. The electronics enclosure may be a server rack or a case of a computer or server.

### FIELD

The present disclosure relates to acoustic panels. In particular, the present disclosure relates to acoustic panels adapted for use with computers, servers, and server racks.

### BACKGROUND

Acoustic panels may be used as a barrier and/or to absorb to reduce sound. However, various environments and applications may have specific needs for the type of acoustic panel, including sound absorption frequency, sound reduction, rigidity, weight, thickness, air flow, fire resistance, etc.

It would be desirable to provide an acoustic absorbing panel suitable for use with computers, servers, and server racks. It would further be desirable to provide an acoustic absorbing panel that accommodates the needs, such as sound absorption frequency, sound reduction, rigidity, weight, thickness, air flow, fire resistance, etc., of panels used with computers, servers, and server racks.

### SUMMARY

An acoustic absorbing panel adapted for use with computers and servers includes a first layer and an opposing second layer, and a core disposed between the first and second layers, the core comprising walls extending between the first layer and the second layer and defining a series of cells, each cell being at least partially surrounded by a wall, adjacent cells of the series of cells being interconnected via an opening in the at least one wall. The panel includes a through hole in the first layer or the second layer. The hole may be aligned with a cell in a series of cells. The panel has an absorption band at a frequency between 800 Hz and 12000 Hz. The panel may include a flame resistant polymer composition.

An electronics enclosure includes a frame constructed to house electronics components; an acoustic absorbing panel mounted on the frame, where the panel includes a first layer and an opposing second layer, and a core disposed between the first and second layers, the core having walls extending between the first layer and the second layer and defining a series of cells, each cell being at least partially surrounded by a wall, adjacent cells of the series of cells being interconnected via an opening in the at least one wall. The panel includes a through hole in the first layer or the second layer. The hole may be aligned with a cell in a series of cells. The panel has an absorption band at a frequency between 800 Hz and 12000 Hz. The electronics enclosure may be a server rack or a case of a computer or server.

### BRIEF DESCRIPTION OF FIGURES

FIG. 1A is a perspective view of an exemplary electronics server rack with sound absorbing panels according to an embodiment.

FIG. 1B is an exploded view of the electronics server rack of FIG. 1A.

FIG. 2 is a schematic view of a sound absorbing panel according to an embodiment.

FIG. 3A is a partial cross sectional top view of the panel of FIG. 2.

FIG. 3B is a cross-sectional view of the exemplary panel of FIG. 3A.

FIG. 3C is a perspective view of a cell from FIG. 3B.

FIGS. 4A-4L are top views of exemplary panels with varying shapes of interconnected cells according to an embodiment.

FIG. 5 is a schematic of a sound-absorbing panel used in the Examples.

FIG. 6 is a schematic of a sound-absorbing panel used in the Examples.

FIG. 7 are schematic views of the test set-ups used in the Examples.

### DETAILED DESCRIPTION

The present disclosure relates to acoustic sound-absorbing panels. In particular, the present disclosure relates to acoustic sound-absorbing panels adapted for use with computers, servers, and server racks.

The terms “integral” and “integrally formed” are used in this disclosure to describe elements that are formed in one piece (a single, unitary piece) and cannot be separably removed from each other without causing structural damage to the piece.

The term “interconnected” is used here to refer to spaces (e.g., internal portions of cells) that are in fluid communication with one another.

The terms “flame retardant,” “flame resistant,” and “fire resistant” are used to refer to characteristics of materials that slow down ignition and flame propagation relative to other materials.

Relative terms such as proximal, distal, left, right, forward, rearward, top, bottom, side, upper, lower, horizontal, vertical, and the like may be used in this disclosure to simplify the description. However, such relative terms do not to limit the scope of the invention in any way. Terms such as left, right, forward, rearward, top, bottom, side, upper, lower, horizontal, vertical, and the like are from the perspective observed in the particular figure.

The term “substantially” as used here has the same meaning as “significantly,” and can be understood to modify the term that follows by at least about 75%, at least about 90%, at least about 95%, or at least about 98%. The term “not substantially” as used here has the same meaning as “not significantly,” and can be understood to have the inverse meaning of “substantially,” i.e., modifying the term that follows by not more than 25%, not more than 10%, not more than 5%, or not more than 2%.

The term “about” is used here in conjunction with numeric values to include normal variations in measurements as expected by persons skilled in the art, and is understood have the same meaning as “approximately” and to cover a typical margin of error, such as ±5% of the stated value.

Terms such as “a,” “an,” and “the” are not intended to refer to only a singular entity, but include the general class of which a specific example may be used for illustration.

The terms “a,” “an,” and “the” are used interchangeably with the term “at least one.” The phrases “at least one of” and “comprises at least one of” followed by a list refers to any one of the items in the list and any combination of two or more items in the list.

As used here, the term “or” is generally employed in its usual sense including “and/or” unless the content clearly dictates otherwise. The term “and/or” means one or all of the listed elements or a combination of any two or more of the listed elements.

The recitations of numerical ranges by endpoints include all numbers subsumed within that range (e.g., 1 to 5 includes 1, 1.5, 2, 2.75, 3, 3.80, 4, 5, etc. or 10 or less includes 10, 9.4, 7.6, 5, 4.3, 2.9, 1.62, 0.3, etc.). Where a range of values is “up to” or “at least” a particular value, that value is included within the range.

The words “preferred” and “preferably” refer to embodiments that may afford certain benefits, under certain circumstances. However, other embodiments may also be preferred, under the same or other circumstances. Furthermore, the recitation of one or more preferred embodiments does not imply that other embodiments are not useful, and is not intended to exclude other embodiments from the scope of the disclosure, including the claims.

All references and publications cited herein are expressly incorporated herein by reference in their entirety into this disclosure, except to the extent they may directly contradict this disclosure. Although specific embodiments have been illustrated and described herein, it will be appreciated by those of ordinary skill in the art that a variety of alternate and/or equivalent implementations can be substituted for the specific embodiments shown and described without departing from the scope of the present disclosure.

Server rooms, and in particular server rooms with multiple servers mounted on server racks can be noisy due to the operation of cooling fans. However, it has been found that hard disk drives are sensitive to high frequency sound. A recent study by T. Dutta (Master's Thesis, Michigan Technological University, December 2017) showed that the performance of hard disk drives from multiple manufacturers can be adversely affected by sound levels above 90 dB. Certain sound frequencies correspond to the modal frequencies of the platters of the hard disk drives. Such frequencies occur around 1100 Hz, 1800 Hz, 3100 Hz, 4600 Hz, 6350 Hz, and 7900 Hz. Loud sounds at or around these frequencies may negatively affect hard disk drive performance. The sound level above which performance begins to be adversely affected varies and may depend on the individual hard disk drive. Others have shown that selective excitation of the hard disk drives platter modal frequencies could result in hard disk drive failure and could be exploited for a denial of service attack for example (M. Shahrad et al., Acoustic Denial of Service Attacks on Hard Disk Drives, 2018 Workshop on Attacks and Solutions in Hardware Security (ASHES 2018), Toronto, Canada). Systems used to cool computers or servers may create noise at or around the frequencies that may negatively impact hard disk drive performance.

Sound-absorbing panels are sometimes used to reduce sound in various structures, including rooms inside buildings, and cars. Such panels are typically provided with qualities specific to the intended use. For example, the sound-absorbing panels may be adapted to have specific thickness, rigidity, sound reduction level, sound frequency, and other properties.

There exists a need for panels that are suitable for use with computers, servers, and server racks. It would be desirable to provide an acoustic absorbing panel with features that accommodate computers, servers, and server racks, such as peak sound absorption frequencies, sound reduction, rigidity, weight, thickness, air flow management, heat resistance, fire resistance, etc.

Simply adding mass to individual enclosures or the electronics rack to reflect the sound energy is not desirable. Electronics server racks may be limited in their capacity based on floor weight limitations (typically less than 3500 lbs. for the full rack), and adding heavy metal panels to reduce sound could limit the overall density of electronic equipment in the data center. Therefore, light weight electronic enclosures are desirable. Further, lightweight electronic enclosures may enable one-person serviceability.

Sound-absorbing panels according to the present disclosure exhibit sound absorption at relevant frequencies, sound reduction, rigidity, weight, thickness, air flow management, heat resistance, fire resistance, etc., suitable for use with computers, servers, and server racks. The use of the sound-absorbing panels is not limited to the specified uses (e.g., computers, servers, and server racks), and the sound-absorbing panels are also usable with other structures and devices that can benefit from similar characteristics.

The sound-absorbing panels of the present disclosure may be thin, light weight, rigid, and/or may be made of recyclable thermoplastic materials. The panels may be added to an existing structure (e.g., frame) of a computer, server, or server rack, or may be used to construct the computer, server, or server rack. In the case of server racks, it may be desirable to attach the sound-absorbing panel to the rack without the use of external fasteners. This may help with tamper proofing the rack. For example, the sound absorbing panel can be configured to mount to a recessed bezel on the side panels of the rack frame using a strong, permanent adhesive tape such as VHB tape manufactured by 3M Company, St. Paul, Minn.

According to an embodiment, the sound-absorbing panel has a layered structure including first and second layers and a core between the first and second layers. The first and second layers may also be characterized as a “skin” on the core. The core includes a plurality of walls extending between the first and second layers and dividing the space between the first and second layers into series of interconnected cells. The cells are interconnected via openings in at least some of the walls. Some or all of the series of interconnected cells may be in fluid communication with the outside environment via one or more holes in the first and/or second layers.

Each of the first and second layers has outer surfaces facing the outside of the panel, and inner surfaces facing the core. According to an embodiment, the first layer and/or the second layer includes one or more openings connecting the cells within the core to the outside environment. In some embodiments, the second layer is free of any openings connecting the cells within the core to the outside environment.

The core includes a plurality of walls extending between the first layer and the second layer (e.g., from the second (inner) surface of the first layer to the first (inner) surface of the second layer). The core defines one or more series of interconnected cells within the core. Each cell in a series of cells is at least partially surrounded by a wall.

Within a given series of interconnected cells, the cells are interconnected (e.g., are in fluid communication) via an opening in a wall between adjacent cells. The sound reduction frequency may be adjusted by adjusting various aspects of the cells, including the size of the opening in the wall.

The sound-absorbing panel may be capable of absorbing sounds at a broad frequency range. Preferably, the sound-absorbing panel is capable of absorbing sounds at a frequency range that includes frequencies that may cause problems with computer hard drives. For example, the sound-absorbing panel is capable of absorbing sound waves transmitted by air. According to an embodiment, the sound-absorbing panel is constructed to absorb sounds at least at an acoustical frequency of 300 Hz or above, 500 Hz or above, 800 Hz or above, 1000 Hz or above, 1400 Hz or above, 1600 Hz or above, 1800 Hz or above, 1900 Hz or above, 2000 Hz or above, or 2100 Hz or above. The sound-absorbing panel may be constructed to absorb sounds at least at an acoustical frequency of 12000 Hz or lower, 10000 Hz or lower, 8000 Hz or lower, 6000 Hz or lower, 4000 Hz or lower, 3500 Hz or lower, 3000 Hz or lower, 2800 Hz or lower, or 2500 Hz or lower.

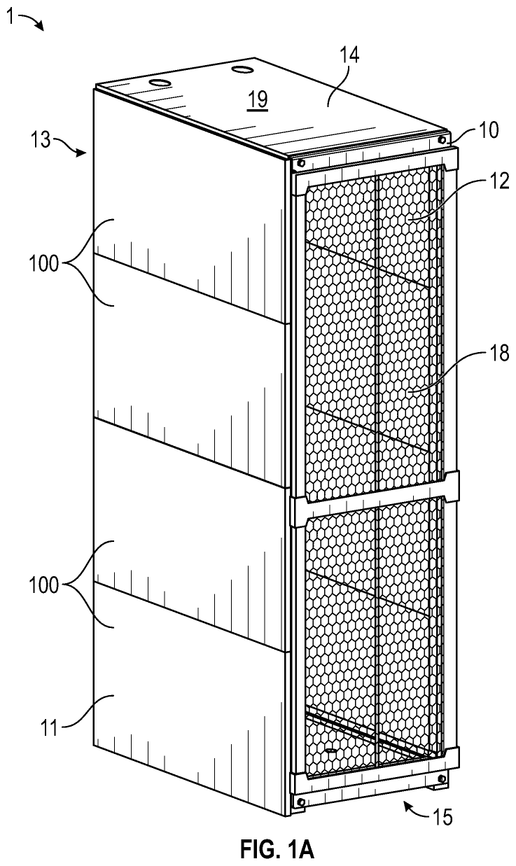

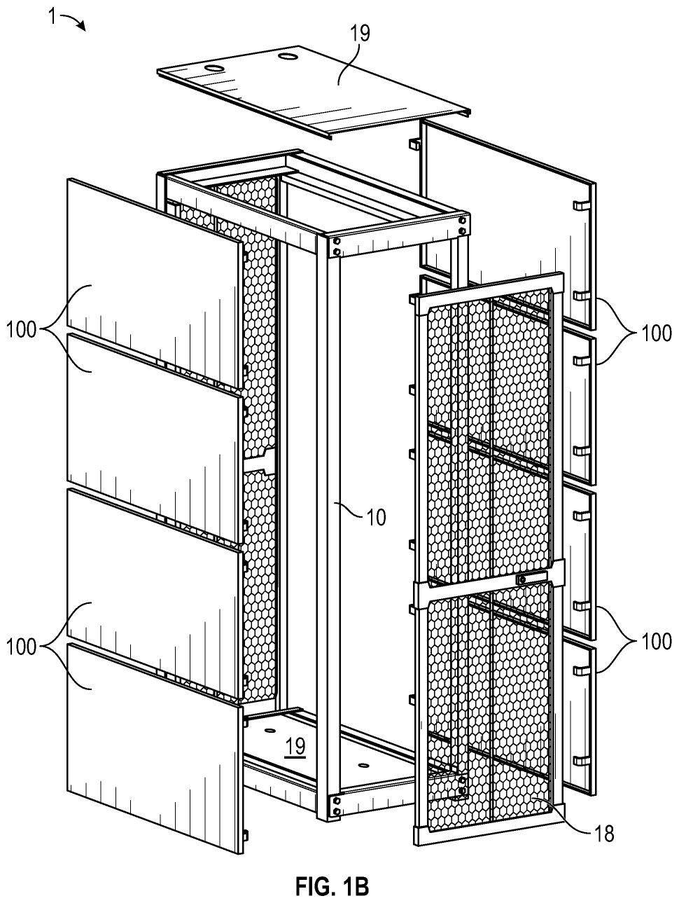

FIG. 1A illustrates schematically a structure 1 with a frame 10 and sound-absorbing panels 100 mounted onto the frame 10. FIG. 1B is an exploded view of the structure 1. The structure 1 may be, for example, an electronics server rack constructed to house hard disk drives and/or other electronics. The sound-absorbing panels 100 may be mounted onto the sides 11, front 12, back 13, top 14, and/or bottom 15 of the frame 10. In some embodiments, the sound-absorbing panels 100 may be mounted onto the frame 10 to cover the entire side 11 or both sides 11 of the frame 10. In other embodiments, the sound-absorbing panels 100 may be mounted to cover only a part of the side 11, front 12, back 13, top 14, and/or bottom 15 of the frame 10. The sound-absorbing panels 100 mounted onto the frame 10 can be made up of multiple pieces, as shown, or may be constructed as a single piece that covers the intended area of the frame 10. The structure 1 may include additional panels, such as side, front, back, top, and/or bottom panels that may or may not be sound-absorbing. The structure 1 may also include additional panels that facilitate air flow, such as perforated or mesh panels. In the embodiment shown, both sides 11 of the structure 1 are covered by sound-absorbing panels 100, the front and back have mesh screen panels 18, and the top and bottom have conventional panels 19.

The sound-absorbing panel 100 may also be mounted onto a frame or a case housing a computer, or the sound-absorbing panel 100 may be used to construct the frame or the case. The sound-absorbing panel 100 may form a side, front, back, top, or bottom of the frame or case, or a part thereof.

The sound-absorbing panel 100 may include one or more mounting elements 102 that facilitate mounting and attachment of the panel 100 onto the rack 1. In some embodiments, the frame 110 includes one or more mounting elements 102 that facilitate tool-less mounting, attachment, unmounting, and detachment of the panel 100. The mounting elements 102 may include any suitable structure, such as a protrusion, tab, retention hook, alignment peg, clip, or combination thereof, shaped to facilitate releasable mounting and attachment.

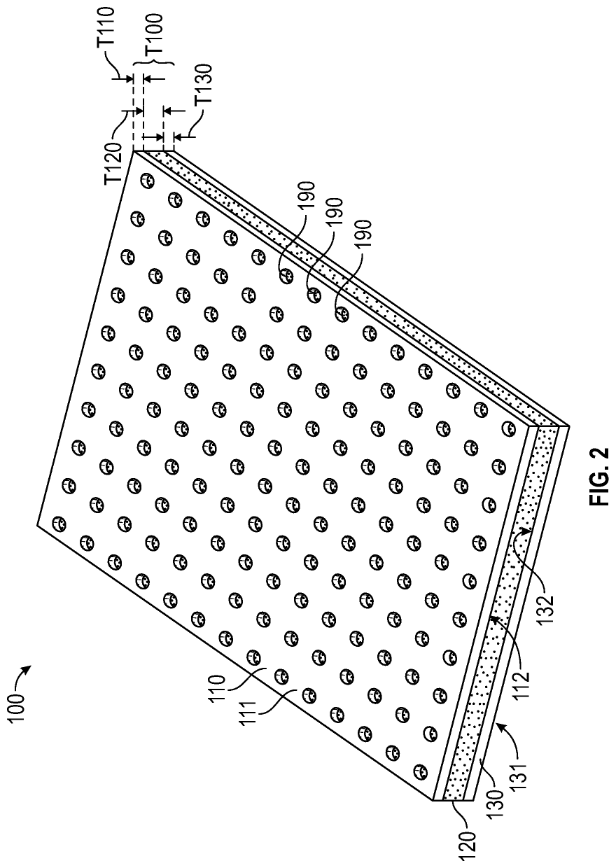

FIG. 2 is a schematic perspective view of a sound-absorbing panel 100 according to an embodiment. The panel 100 has a layered structure including a first layer 110 and an opposing second layer 130 and a core 120 between the first and second layers 110, 130. Each of the first and second layers 110, 130 has an outer surface 111, 131 and an opposed inner surface 112, 132, with the inner surface 112, 132 facing the core 120 and the outer surfaces 111, 131 facing away from the core 120 (e.g., facing the outside of the panel). In some embodiments, the first layer 110 and/or the second layer 130 include one or more through holes 190 connecting the core 120 (e.g., cells within the core 120) to the outside environment. In some embodiments, the second layer 130 is free of any through holes connecting the cells within the core to the outside environment.

The panel 100 has a thickness T100. The thickness T100 may be made up of the thickness T110 of the first layer 110, thickness T130 of the second layer 130, and thickness T120 of the core 120. The sound-absorbing panel 100 can be cut to any desired shape and size to accommodate the intended use. Although a flat panel with generally planar first and second layers 110, 130 is shown, the sound-absorbing panel 100 can also be shaped to have a curved contour if desired.

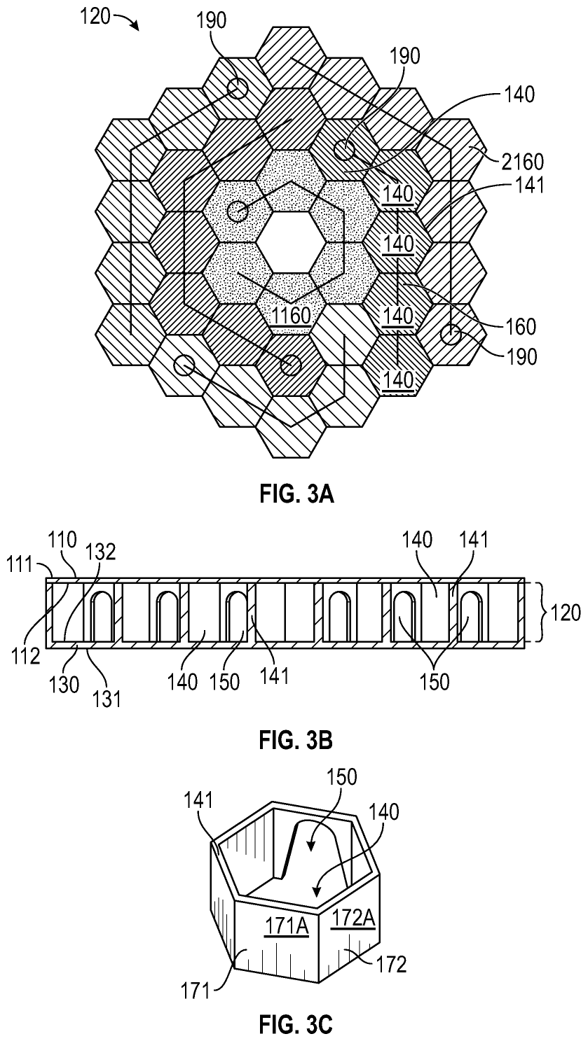

The structure of the core 120 is illustrated in FIGS. 3A-3C. FIG. 3A is a top view of a section of the core 120. The core 120 includes a plurality of walls 141 extending between the first and second layers 110, 130. The walls 141 divide the space between the first and second layers 110, 130 into cells 140. The cells 140 form one or more series of cells 160, where cells 140 of a series 160 are interconnected (e.g., in fluid communication with each other) via openings 150 in at least some of the walls 141 between adjacent cells 140. The series 160 of interconnected cells 140 are indicated schematically in FIG. 3A with a line connecting the cells within each series. Also shown are second, third, and subsequent series 1160, 2160 of cells. Each series 160, 1160, 2160, etc. of cells may independently include any suitable number of cells 140, such as 1 or more, 2 or more, 3 or more, 4 or more, 5 or more, 6 or more, or 7 or more cells 140. Each series 160, 1160, 2160, etc. may include up to 40, up to 30, up to 25, up to 20, up to 15, or up to 10 cells. The series 160, 1160, 2160, etc. of cells in a given panel 100 may include different numbers of cells 140. In other words, all the series 160, 1160, 2160, etc. of cells do not need to include an equal number of cells 140 but the numbers of cells 140 in each series 160, 1160, 2160, etc. may be independent of the other series of the panel. Generally, the number of series in a given panel 100 is not limited and will depend on the size of the panel and the number and size of cells in each series. Typically, a panel 100 includes a plurality of series 160 that cover the area between the first and second layers 110, 130.

In the embodiment shown in FIGS. 3A-3C, each cell wall 141 has a plurality of sides 171, 172. Cell wall side 171, 172 has area 171A, 172A. An opening 150 in cell wall 141 a has area 150A. The area 150A of the opening 150 may be at least 50%, at least 55%, at least 60%, at least 65%, at least 70%, or at least 80% of the area 171A, 172A of the side 171, 172.

The openings 150 may have any suitable shape. In the example shown, the openings 150 are generally U-shaped, having curved and straight portions. The straight portions may be either perpendicular to, or tilted at another angle to layers 110 and 130. Alternatively, the openings 150 may have only cured portions or only straight portions. In some embodiments, at least 50 (or at least 55, at least 60, at least 65, at least 70, at least 75, at least 80, at least 85, at least 90, at least 95, or 100) percent of openings 150 in the cell walls 141 emanate from either the first layer 110 or the second layer 130.

At least some of the series 160 of cells may be in fluid communication with the outside environment via one or more through holes 190 in the first and/or second layers 110, 130. The position of the through holes 190 is indicated schematically in FIG. 3A. According to an embodiment, the first layer 110 or the second layer 130 includes at least one through hole or a plurality of through holes. In some embodiments, all of the through holes 190 are on one of the first and second layers 110, 130 (e.g., on the first layer 110), and the other of the first and second layers 110, 130 (e.g., the second layer 130) is free of any through holes. In the example, shown, first layer 110 has at least a first through hole 190 extending through the first layer 110 into at least one cell 140 in a series 160 of cells.

Although through holes 190 are displayed as circles, the through holes can have any of a variety of shapes including squares, triangles, rectangles, hexagons, or other polygons. Multiple openings could also be used, including openings formed by at least two holes, or openings which include a woven or non-woven permeable material covering the hole. The embodiment shown in FIG. 3A has a single cell at the center that is not connected to a series of cells through an opening. The center cell may optionally have a through hole in the first or second layer 110, 130.

In some embodiments, the series 160 of cells is a chain of consecutive interconnected cells 140 that has a first cell and a last cell in the series 160 and optionally one or more intermediate cells. The through hole in the first layer or the second layer may be aligned with a cell in the series of cells. For example, through hole 190 may extend into and be aligned with either the first or last cell in the series 160. The panel may include a plurality of through holes in the first layer or the second layer, and each of the plurality of through holes may be aligned with a cell in one of the series of cells. In some embodiments, each series 160 is aligned with only a single through hole 190 through the first or second layer 110, 130. In some embodiments the through hole 190 extends into a cell other than the first or last cell of the series 160 (e.g., an intermediate cell or a middle cell). In other embodiments, the series 160 of cells is aligned with more than one through hole 190.

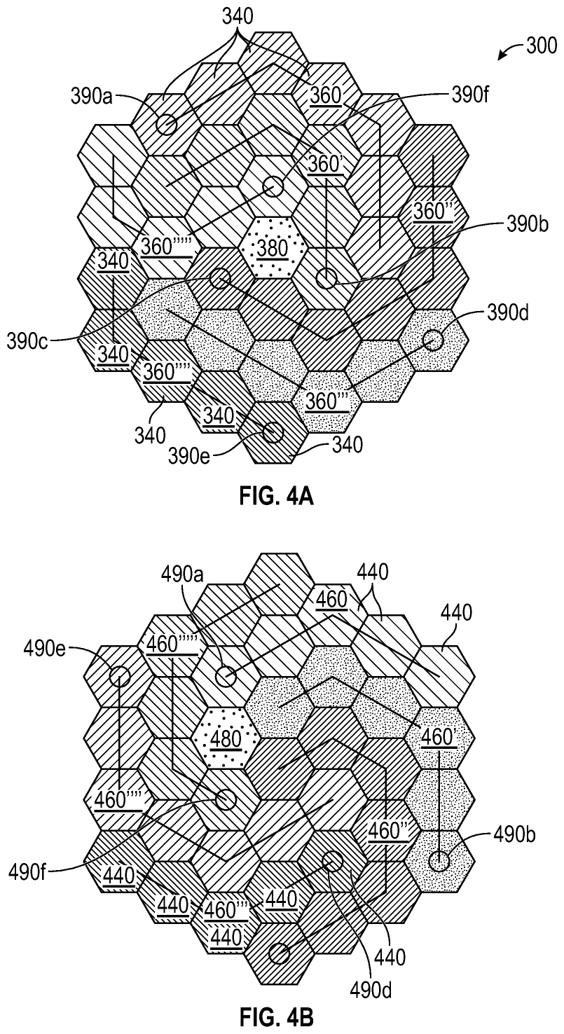

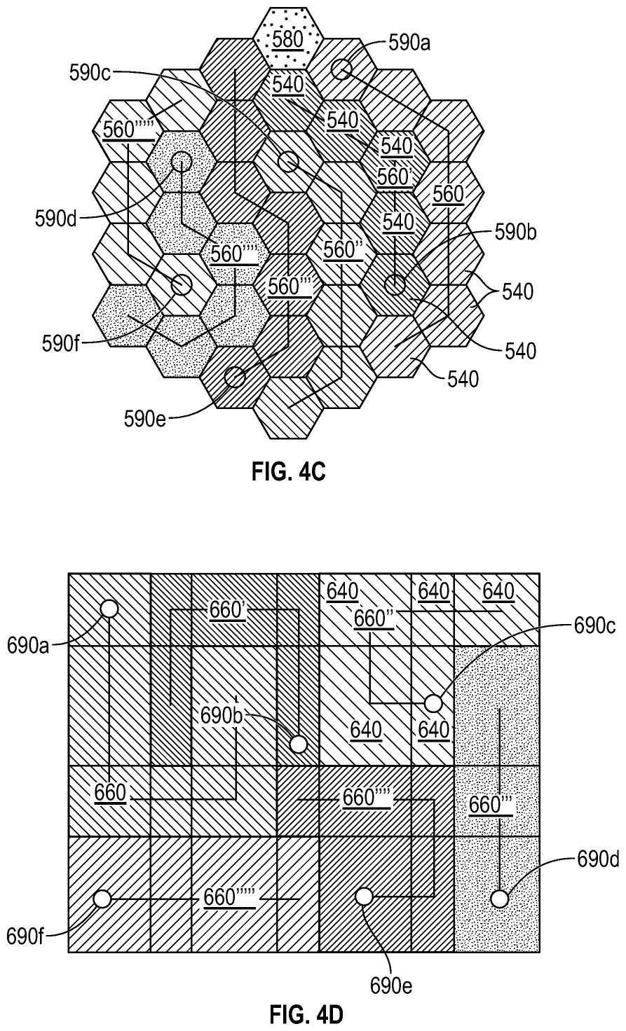

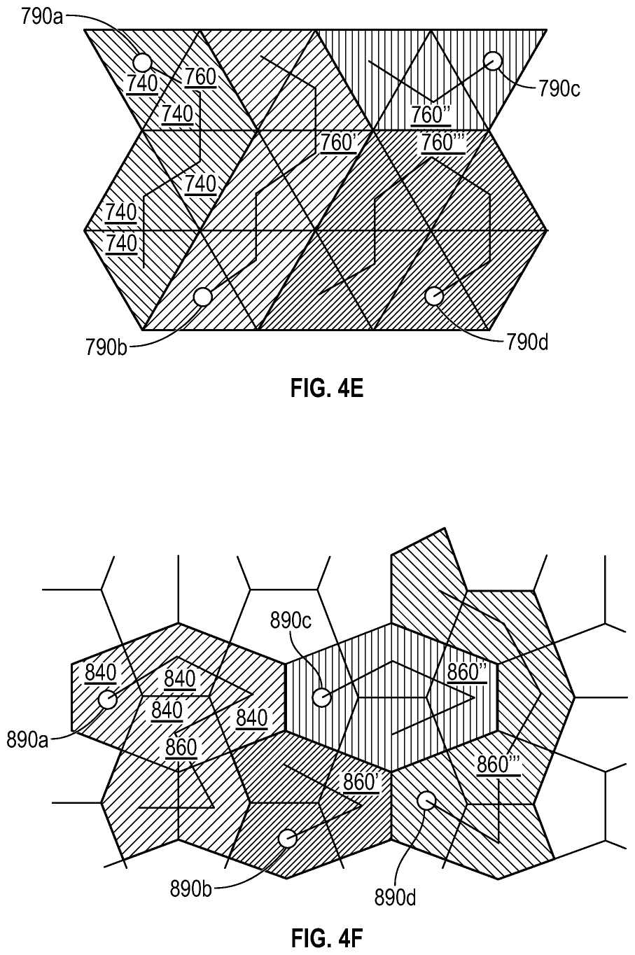

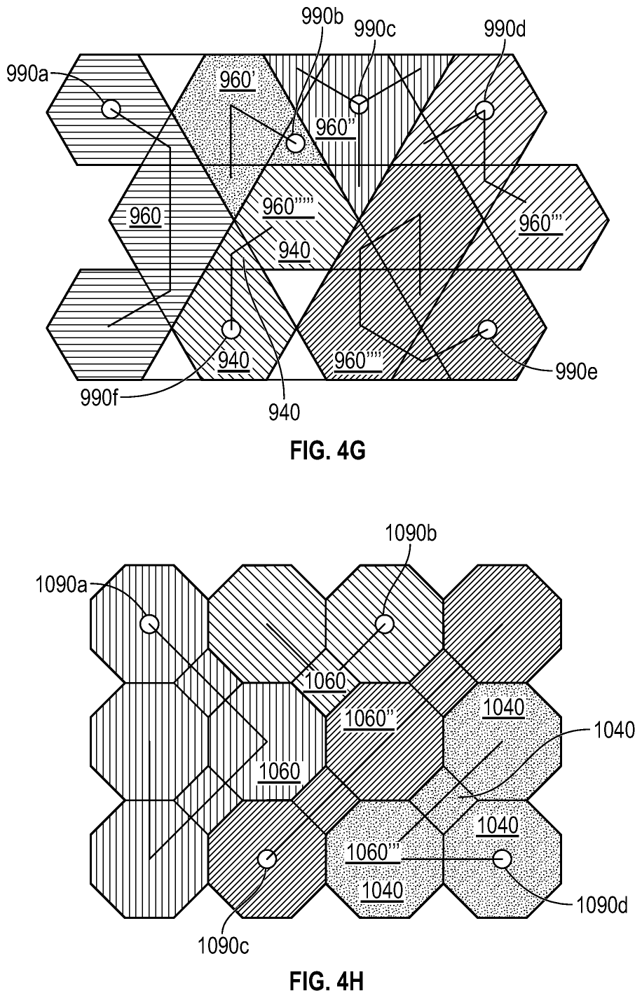

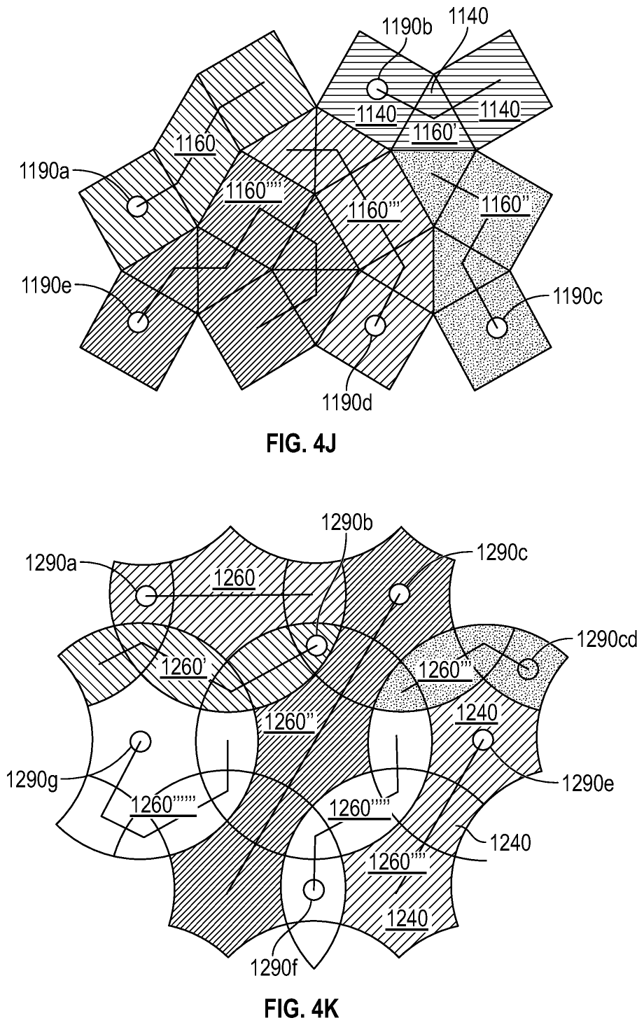

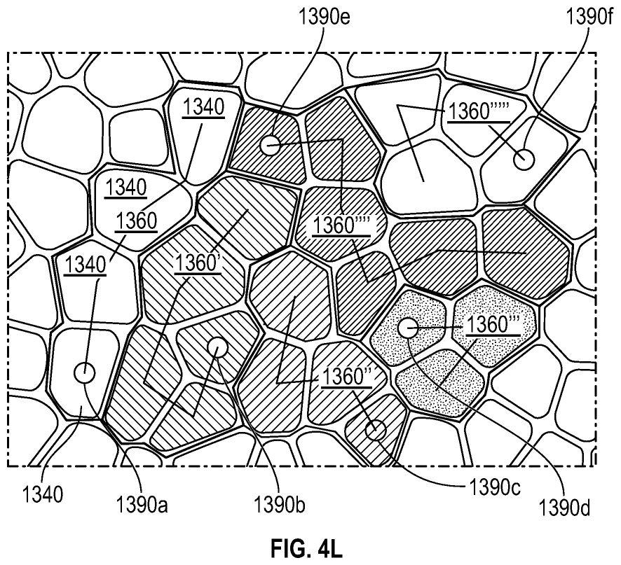

Various alternative examples of the arrangement and shapes of cells 140 and series 160 of cells in sound-absorbing panels 100 are shown in FIGS. 4A-4L. The cells 140 of the panel may have any suitable shape. For example, the cells 140 may have a regular geometric shape, such as a polygonal shape. Exemplary shapes include triangles, squares, rectangles, pentagons, hexagons, heptagons, octagons, etc., and combinations thereof. The cells 140 may also have an irregular shape and may include curved and/or straight sections. The series 160 of cells may form a pattern. The pattern may be regular or irregular. In some embodiments, the series 160 of cells is in a regular pattern.

For example, FIG. 4A shows a group of regular repeating hexagonal arrays 360, 360′, 360″, 360′″, 360″″, 360′″″ of connected cells 340 and through holes 390a, 390b, 390c, 390d, 390e, 390f. Cell 380 could be added to the 360′, 360″, or 360′″″ series of connected cells or stand alone.

FIG. 4B shows a group of spiral repeating hexagonal array 460, 460′, 460″, 460′″, 460″″, 460′″″ of connected cells 440 and through holes 490a, 490b, 490c, 490d, 490e, 490f. Cell 480 could be added to the 460, 460′, 460″, or 460′″″ series of connected cells or stand alone.

FIG. 4C shows a group of semi-spiral repeating hexagonal array 560, 560′, 560″, 560′″, 560″″, 560′″″ of connected cells 540 and through holes 590a, 590b, 590c, 590d, 590e, 590f. Cell 580 could be added to the 560, 560′, or 560′″ series of connected cells or stand alone.

FIG. 4D shows an exemplary group of rectangular arrays 660, 660′, 660″, 660′″, 660″, 660′″″ of connected cells 640 and through holes 690a, 690b, 690c, 690d, 690e, 690f.

FIG. 4E shows an exemplary group of triangular arrays 760, 760′, 760″, 760′″ of connected cells 740 and through holes 790a, 790b, 790c, 790d, 790e.

FIG. 4F shows an exemplary group of pentagonal arrays 860, 860′, 860″, 860′″ of connected cells 840 and through holes 890a, 890b, 890c, 859d, 890e.

FIG. 4G shows an exemplary group of connected triangles and hexagons 906, 960′, 960″, 960′″, 960″″, 960′″″ of connected cells 940 and through holes 990a, 990b, 990c, 990d, 990e, 990f.

FIG. 4H shows an exemplary group of connected octagons and squares 1060, 1060′, 1060″, 1060′″ of connected cells 1040 and through holes 1090a, 1090b, 1090c, 1090d.

FIG. 4J shows an exemplary group of squares and triangles 1160, 1160′, 1160″, 1160′″, 1160″″ of connected cells 1140 and through holes 1190a, 1190b, 1190c, 1190d, 1190e.

FIG. 4K shows an exemplary array of mixed shapes 1260, 1260′, 1260″, 1260′″, 1260″″, 1260′″″, 1260″″″ of connected cells 1240 and through holes 1290a, 1290b, 1290c, 1290d, 1290e, 1290f, 1290g.

FIG. 4L shows an exemplary array of random shapes 1360, 1360′, 1360″, 1360′″, 1360″″, 1360′″″ of connected cells 1340 and through holes 1390a, 1390b, 1390c, 1390d, 1390e, 1390f.

In some embodiments the cells wall 160 have a plurality of sides 171. For example, the wall 160 of each cell 150 may have at least 3, at least 4, at least 5, at least 6, at least 7, or at least 8 sides 171. In other embodiments, the wall 160 may have an organic shape without distinct angles or sides, as shown, for example, in FIG. 4L. In such embodiments, a “side” may be considered to be a section of wall 160 between two adjacent cells 140.

In some embodiments, at least one of the first or second layer 110, 130 is free of through holes 190.

In some embodiments, the panel includes a first layer and an opposing second layer, and a core disposed between the first and second layers. The core (e.g., the walls of the core) may extend from an inner surface of the first layer to an inner surface of the second layer. In other embodiments, the panel may include additional layers disposed either on the outside surface of the first and/or second layer or on the inside surface of the first and/or second layer (e.g., between the core and the inside surface of the first and/or second layer).

The acoustic characteristics of the panel may be adjusted to accommodate its intended use. In some embodiments, the acoustic characteristics of the panel are adjusted to accommodate use with computers, servers, or server racks. In some embodiments, one or more of the panel thickness, cell sizes, size of openings between adjacent cells, size of through holes in the first and/or second layers, and number of connected cells are adjusted to adjust (e.g., tune) the absorption bands of the panel. For example, a peak absorption frequency may be increased by having fewer number of interconnected cells in a series of cells, by decreasing the size of individual cells (e.g., by decreasing the width of the cells or the height of the cells (i.e., the thickness of the core)), by increasing the size of the through holes in the first and/or second layer, by increasing the size of the openings in the walls between adjacent cells, or by decreasing the thickness of the first and/or second layers. The opposite adjustments can be used to decrease peak absorption frequency of the panel.

The panel may be constructed to have at least one absorption band at a frequency greater than 300 Hz, greater than 500 Hz, greater than 800 Hz, greater than 1000 Hz, greater than 1200 Hz, greater than 1400 Hz, greater than 1600, greater than 1800 Hz, greater than 2000 Hz, or greater than 2100 Hz. The panel may be constructed to have at least one absorption band at a frequency less than 12000 Hz, less than 10000 Hz, less than 8000 Hz, less than 6000 Hz, less than 4000 Hz, less than 3500 Hz, less than 3200 Hz, less than 3000 Hz, less than 2800 Hz, or less than 2600 Hz. The panel may have multiple absorption bands. The absorption bands may be measured using the “Normal Incidence Acoustical Absorption Test” and the “Reverberation Chamber Test” as described in WO2018034949 to Jonza et al.

In some embodiments, the panel exhibits an acoustical absorption of at least 50%, at least 55%, at least 60%, at least 65%, at least 70%, at least 75%, or at least 80%. The acoustical absorption of the panels may be measured using the “Normal Incidence Acoustical Absorption Test” and the “Reverberation Chamber Test” as described in WO2018034949 to Jonza et al.

According to some embodiments, each cell has a largest distance between two opposed walls of at least 3 mm, at least 5 mm, at least 10 mm, at least 15 mm, at least 20 mm, at least 25 mm, or at least 30 mm. The largest distance between two opposed walls may be up to 40 mm, up to 30 mm, or up to 20 mm. Each cell may have a largest distance between two opposed vertices of at least 5 mm at least 10 mm, at least 15 mm, at least 20 mm, at least 25 mm, at least 30 mm, at least 35 mm, or at least 40 mm. The largest distance between two opposed vertices may be up to 50 mm, up to 45 mm, up to 40 mm, or up to 35 mm.

According to some embodiments, each cell 140 has a height that is equivalent to the thickness T120 of the core 120 and may be measured as a distance from the inner surface 112 of the first layer 110 to the inner surface 131 of the second layer 130. The thickness T120 may be at least 2 mm, at least 3 mm, 4 mm, at least 5 mm, at least 6 mm, at least 7 mm, at least 8 mm, at least 9 mm, at least 10 mm, or at least 15 mm. The thickness T120 may be up to 30 mm, up to 25 mm, up to 20 mm, up to 15 mm, or up to 10 mm.

According to some embodiments, each cell 140 has a volume V140 of at least 0.04 cm³, at least 0.1 cm³, at least 0.5 cm³, at least 1 cm³, at least 2 cm³, at least 3 cm³, at least 4 cm³, at least 5 cm³, at least 10 cm³, at least 15 cm³, at least 20 cm³, at least 25 cm³, or at least 30 cm³. The volume V140 may be up to 40 cm³, up to 35 cm³, up to 30 cm³, or up to 25 cm³.

According to some embodiments, a series 160 of cells may have a volume V160 that is a cumulative volume of the cells in the series. The volume V160 may be at least 0.5 cm³, at least 1 cm³, at least 2 cm³, at least 3 cm³, at least 4 cm³, at least 5 cm³, at least 10 cm³, at least 15 cm³, at least 20 cm³, at least 25 cm³, at least 50 cm³, at least 75 cm³, at least 100 cm³, at least 150 cm³, or at least 200 cm³. The volume V160 may be up to 250 cm³, up to 200 cm³, or up to 150 cm³. The series 160 of cells may have a length L160 that is a longest cumulative length of successive cells in the series. The length L160 may be at least 20 mm, at least 30 mm, at least 40 mm, at least 50 mm, at least 75 mm, at least 100 mm, at least 150 mm, or at least 200 mm. The length L160 may be up to 300 mm, up to 250 mm, or up to 200 mm.

The first and second layers 100, 130 may have any suitable thickness T110, T130. For example, the first and second layers 100, 130 may independently have a thickness T110, T130 of at least 0.01 mm, at least 0.05 mm, at least 0.1 mm, at least 0.25 mm, at least 0.5 mm, at least 1 mm, at least 1.5 mm, at least 2 mm, at least 2.5 mm, or at least 3 mm. The thickness T110, T130 may be up to 5 mm, up to 4 mm, or up to 3 mm.

The panel 100 may have a thickness T100 of at least 4 mm, at least 7 mm, at least 10 mm, or at least 15 mm. The thickness T100 may be up to 30 mm, up to 20 mm, up to 15 mm, or up to 10 mm.

The cell walls 141 may have a thickness T141 of at least 0.01 mm, at least 0.05 mm, at least 0.1 mm, at least 0.2 mm, or at least 0.5 mm. The thickness T141 may be up to 2 mm, up to 1 mm, up to 0.5 mm, or up to 0.2 mm.

The physical characteristics, such as weight, rigidity, compression strength, etc., of the panel may be adjusted to accommodate its intended use. In some embodiments, the physical characteristics of the panel are adjusted to accommodate use with computers, servers, or server racks. In some embodiments, the panel has a flexural rigidity of at least 1 N·m², at least 5 N·m², at least 10 N·m², at least 15 N·m², at least 20 N·m², at least 25 N·m², at least 30 N·m², at least 35 N·m², at least 40 N·m², at least 45 N·m², at least 50 N·m², at least 55 N·m², or at least 60 N·m² per meter of width. The panel may have a flexural rigidity of up to 75 N·m², up to 70 N·m², up to 65 N·m², up to 60 N·m², or up to 55 N·m² per meter of width. The flexural rigidity of the panels may be measured using the “3 Point Flexure Test” as described in WO2018034949 to Jonza et al.

In some embodiments, the panel has a compression strength of at least 0.35 MPa, at least 0.5 MPa, at least 1 MPa, at least 1.5 MPa, at least 2 MPa, at least 3 MPa, or at least 4 MPa. The panel may have a compression strength of up to 8 MPa, up to 6 MPa, or up to 5 MPa. The compression strength of the panels may be measured using the “Compression Test” as described in WO2018034949 to Jonza et al.

Advantageously, in some embodiments, the panel has a thickness in a range from 3 mm to 12 mm, 3.5 mm to 10 mm, or 4 mm to 8 mm, and exhibits at least one absorption band in the range of 500 Hz to 12000 Hz, 800 Hz to 11000 Hz, 1800 Hz to 10000 Hz, or 2000 Hz to 8000 Hz.

The sound-absorbing panel 100 may be prepared from any suitable materials. For example, the first and second layers 110, 130 and/or the core 120 may be independently made of polymeric materials, metallic materials, ceramic materials, composite materials (e.g., fiber reinforced, woven or non-woven in a resin matrix), or any combinations thereof. In some embodiments the sound-absorbing panel 100 is free of fibrous sound-absorbing materials. For example, the sound-absorbing panel 100 may be free of fibrous sound-absorbing materials that are not part of a composite, such as a layer of THINSULATE Acoustic Insulation™.

Exemplary polymeric materials suitable for manufacturing the panel 100 (e.g., the first or second layer 110, 130 and/or the core 120) include polyethylenes, polypropylenes, polyolefins, polyvinylchlorides, polyurethanes, polyesters, polyamides, polystyrene, copolymers thereof, and combinations thereof (including blends). The polymeric materials may be thermosetting by, for example, heat or ultraviolet (UV) radiation, or thermoplastic.

In some embodiments, the panel (e.g., the first and second layers 110, 130 and/or the core 120) may be manufactured from a high temperature resistant, flame resistant, or flame retardant material. For example, the panel may be manufactured from a high temperature resistant, flame resistant, and/or flame retardant polymer or may include additives that render the material temperature resistant, flame resistant, or flame retardant. Exemplary temperature resistant, flame resistant, or flame retardant polymers include for instance and without limitation, polyamides including PA6, PA66, polybutylene terephthalate (PBT), poly ethylene terephthalate (PET), poly ethylene naphthalate (PEN), polyphenylene sulfide (PPS), Polyether imide (PEI), Polyether sulfone (PES), Polyether ketone (PEK) and Polyether ether ketone (PEEK) and fluoropolymers.

Exemplary additives that may be included in the material of the panel include flame retardants that may be added to the material (e.g., heat resistant polymeric material or other polymeric material) to provide further protection. Useful flame retardants include for instance and without limitation, inorganics such as alumina trihydrate (ATH), huntite and hydromagnesite, various hydrates, phosphorus, boron compounds, antimony trioxide and pentoxide and sodium antimonate; halogenated compounds such as organochlorines including chlorendic acid derivatives and chlorinated paraffins; organobromines such as decabromodiphenyl ether (decaBDE), decabromodiphenyl ethane, polymeric brominated compounds, brominated carbonate oligomers (BCOs), brominated epoxy oligomers (BEOs), tetrabromophthalic anyhydride, tetrabromobisphenol A (TBBPA) and hexabromocyclododecane (HBCD); organophosphates such as triphenyl phosphate (TPP), resorcinol bis(diphenylphosphate) (RDP), bisphenol A diphenyl phosphate (BADP), and tricresyl phosphate (TCP); phosphonates such as dimethyl methylphosphonate (DMMP); and phosphinates such as aluminium diethyl phosphinate; compounds containing both phosphorus and a halogen such as tris(2,3-dibromopropyl) phosphate(brominated tris) and chlorinated organophosphates such as tris(1,3-dichloro-2-propyl)phosphate (chlorinated tris or TDCPP) and tetrakis(2-chlorethyl)dichloroisopentyldiphosphate.

In some embodiments the sound-absorbing panel 100 includes a layer of metal or metalized material (e.g., a metalized polymer layer). For example, one or both of the first and second layers 110, 130 of the sound-absorbing panel 100 may be made from metal or a metalized material. In some embodiments sound-absorbing panel 100 includes a first layer 110 made from metal or metalized material such that when the sound-absorbing panel 100 is mounted on the frame of a rack, the metal faces the interior of the rack.

Exemplary metallic materials suitable for manufacturing the panel 100 (e.g., the first or second layer 110, 130 and/or the core 120) include aluminum, steel, nickel, copper, brass, bronze, and alloys thereof. In some embodiments, the first and/or second layer 110, 130 includes aluminum, steel, nickel, copper, brass, bronze, or alloys thereof.

Exemplary ceramic (including glass, glass-ceramic, and crystalline ceramic) materials suitable for manufacturing the panel 100 (e.g., the first or second layer 110, 130 and/or the core 120) include oxides, nitrides, and carbides.

Exemplary fiber containing materials suitable for manufacturing the panel 100 (e.g., the first or second layer 110, 130 and/or the core 120) include fibers such as cellulose, carbon, thermoplastic fibers (polyamide, polyester, aramid, or polyolefin), steel, and glass, as may be applicable to the particular type of material.

In some embodiments, materials for panels described herein may be in the form of multilayers or laminates. In some embodiments, panels described herein have a single material composition. Such embodiments are desirable to enhance recyclability. The panel 100 (e.g., the first or second layer 110, 130 and/or the core 120) may be constructed from parts or may be partially or fully integral such that some or all of the parts are integrally formed.

Optionally materials for panels described herein may also include fillers, colorants, plasticizers, dyes, etc., as may be applicable to the particular type of material.

In some embodiments, the panel is a laminate panel that includes a plurality of panels laminated or adhered together. For example, the second layer of a first panel may be laminated or adhered to the first layer of a second panel. Further layers or panels may be laminated to form the laminate panel. Alternatively, the panel may include first, second, and third layers (e.g., skin layers), and a core disposed between the first and second layers and between the second and third layers. The panel may include additional alternating layers of cores and skin layers. Any number of layers may be included in the panels: two, three, four, five, six, seven, eight, nine, ten, etc.

The configuration of the laminate panel with two or more panels may have the through holes on one side of the panel or both sides of the panel. The panels may have through holes or may be free of through holes on the layer facing another panel. In embodiments where the interconnecting layers are free of through holes, the stiffness of the panel is increased, and sound may be absorbed that is incident on either side of the panel. In embodiments where the interconnecting layers have through holes, and particularly when the through holes of adjacent panels are aligned, the through holes can be used to increase the effective size of the series of cells. This may be useful for adjusting the frequency bands of the multilayered panel. The hole sizes or perforations in each skin can be of different sizes to tune each side of the panels to a different frequency band. It should be noted that 2, 3, 4, 5 or even 10 or more panels could be connected by welding or adhesives to make a single thicker laminated article.

The panel 100 may include a tie layer on at least a portion of the surface of the first and/or second layers 110, 130 facing the core (e.g., the inner surface 112 of the first layer 110 or the inner surface 131 of the second layer 130). The tie layer may facilitate adhesion between first and/or second layer 110, 130 and the core 120. In some cases, the first and/or second layers 110, 130 and the core 120 may be made of a polymer, and the same polymer may also be used as the tie layer. This approach forms a desirable recyclable panel as all components have substantially the same composition. In some embodiments, similar polymers for both the core 120 and first and/or second layers 110, 130 can be used. In some embodiments, the tie layer may include additives that slow the crystallization rate and/or reduce the viscosity of the polymer used in the tie layer. These minor additives desirably do not affect the recycling of the polymers. In some embodiments, additives that promote a chemical bond between the tie layer and the first and/or second layers 110, 130 and/or the core 120 can be employed. In some embodiments, block copolymers can be useful where the copolymer has blocks containing polymers with affinity for the polymer of the first and/or second layers 110, 130 and blocks with affinity for the polymer of the core 120. In some embodiments, techniques for compatibilizing incompatible polymer blends may be useful. In some embodiments, hot melt adhesives, pressure sensitive adhesives and/or curable adhesives may be used as a tie layer.

Any suitable method may be used to make the panel or an article including the panel. For example, the panel may be made by preparing or obtaining the first layer; preparing or obtaining the second layer; preparing or obtaining the core; and laminating the first and second layers to the core. Each of the layers and the core may be prepared by any known methods, such as molding or extruding. The layers and the core (e.g., a first layer and the core) may also be prepared together as a unitary structure. The panel (e.g., the layers and/or the core) may also be prepared by 3-D printing or by another additive technique.

In some embodiments, an adhesive may be used to laminate the first and/or second layers to the core. In some embodiments, two tie layers may be used to laminate the first and second layers to the core.

In some embodiments, laminating the first layer to the core occurs during extrusion of the core. For example, a film die can be configured to drop the extrudate into the first nip of a 3-roll stack, such that it is between the film used to prepare the first layer and a tooling (middle) roll. The extrudate will solidify while in contact with the tooling roll, and adhere to the first layer. After travelling about 180° around the tooling roll, the first layer side contacts a silicone (third) roll. A belt puller located beyond the silicone roll can be used to control the pulling with a force sufficient to remove the solidified extrudate from the tooling roll. The second layer may be unwound over the top of the belt puller and continuously contact the top belt. A molten tie layer can be delivered (e.g., from a film die connected to another extruder) onto the top of the core just prior to contacting the second layer in the entrance to the belt puller. The tie layer solidifies, bonding the honeycomb to the second layer while being held flat by the belt puller. A panel with first and second layers adhered to the core exits the belt puller.

In some embodiments, the panel is shaped via thermoforming to provide the article. In some embodiments, thermoforming includes heating the panel and applying force to shape the panel against at least one tool. The panel may be heated to a processing temperature where it becomes compliant. The panel is then positioned within a mold, such as between two platens, prior to the platens closing. The panel is shaped by mechanical force from the tool, or by vacuum or pneumatic pressure followed by a cooling period to return the panel to a rigid structure. Exemplary polypropylene (PP) panels can be thermoformed, for example, with the panel pre-heat temperature of 310-350° F. (154-177° C.), mold temperature of 150° F. (66° C.), clamping force of 4,000 lbs. (18.8 kN) and cooling time of 30 seconds.

In another aspect, at least a portion of a panel is placed in an injection molding die and at least one mold structure is overmolded on a surface of the panel in the injection molding die. Mold structures can be applied to any portion of a panel, such as on at least one major surface of the panel, an edge of the panel, or a shaped part of the panel. Additionally, at least one profile element may be molded directly onto the mold structure, on an edge side of the panel, or both. Molding can be used to fabricate structures onto the panel that facilitate attachment of the panel to the rack or computer equipment. For example, molding can be used to provide the panel with alignment fiducials, tabs, or other structures that facilitate mounting of the panel onto the rack. For mounting of the panel to the rack, inserting a metal or composite part that fits the track of the rack into the mold, then overmolding to attach the part to the panel may be advantageous. Using the mold geometry to form tabs, alignment guides, etc. that are attached to the panel by the cooling of the injected resin is another approach to adapt the flat panel for attachment to the server rack. Molded-in features for a snap-fit of the panel are another possibility, and may be particularly useful for a panel serving as a lid. In some embodiments, the injection molding die is configured to reduce or increase a thickness of at least a portion of the panel. Typically, the decrease in thickness is a decrease in the thickness of the core of the panel. Increasing the thickness of a panel may involve pulling a vacuum in the injection molding die to draw out the panel material. In some embodiments, the entire panel is inserted into the injection molding die. Further, a thermoplastic material may be injection molded around the panel to form the mold structure. The panel is optionally preheated prior to placing it within the injection molding die. A panel that has undergone overmolding may be flat or alternatively have a three-dimensional shape.

Another method for making articles from panels includes shaping a panel via compression molding to provide the article. In some embodiments, putting a panel inside of a mold between 2 platens, heating the mold, closing the platens to shape the panel while maintaining pressure during a mold cooling stage provides the article. In some embodiments, the panel must be pre-heated prior to closing the mold to ensure material compliance. Exemplary polypropylene (PP) panels can be compression molded, for example, without panel pre-heating, thermal cycling mold temperatures of 305° F. (152° C.) and 150° F. (66° C.), clamping force of 30,000 lbs. (133.5 kN) and cooling/pressure holding time of 30 seconds.

In certain embodiments, at least one cell is consolidated during the thermoforming, compression molding, or overmolding, and folded over to form a reinforcement bead. When a number of adjacent cells are consolidated and folded over they can form a “hem” having a thickness approximately equal to twice the thickness of the first and second layers of the panel.

The panel 100 may exhibit indicia, such as images or alphanumeric characters. In some embodiments, the indicia includes the mark or label of a trademark or copyrighted material, including a registered trademark or registered copyright as defined under any of the countries, territories, etc., of the world (including the United States). In some embodiments, the indicia is on at least one of the first major surface of the first layer or the second major surface of the second layer.

In some cases, there may be a need for thicker panels, for example, either for increased mechanical rigidity or increased sound absorption. It is possible to combine two panels into a thicker one in several configurations and by several methods. For example, two panels may be positioned so that the walls in the core align in the thickness direction and the panels are adhered together. For example, the panels may be adhered using an adhesive or welded together. As used here, “weld” refers to the attachment of two polymeric materials using heat. Typically, two polymeric materials are welded together by applying heat to a surface of each of the materials, bringing the two heated surfaces together, and allowing the heated surfaces to cool and form a bond, such as through entanglement of polymers from each surface. Pressure is usually applied to hold the two polymeric materials together and promote the formation of a weld between the two polymeric materials as they cool. Welding techniques has the advantage that no new materials are introduced into the construction, possibly preserving recyclability of the finished parts.

In an aspect, the method for making a multilayered panel includes preparing a first panel and a second panel and welding the first and second panels together. The welding may include bringing a first surface of the first panel to a temperature above the melting point of the surface; bringing a second surface of the second panel to a temperature above the melting point of the surface; and holding the second surface in contact with the first surface to form a bond between the surfaces as each of the surfaces cools.

Alternatively, adhesives may be used to join two or more panels together. Pressure sensitive or structural adhesives may be used depending on the desired properties of the finished article. The adhesives may by activated by radiation, such as including ultraviolet, visible, infrared, gamma, or e-beam, or by heating to effect curing. Contact pressure may be sufficient for the pressure sensitive adhesives. Another alternative includes using an extruded tie layer of the same polymer composition to bond two panels together in a continuous process. Preheating of the pre-made panel surfaces and/or a sufficiently high tie layer temperature may be required to provide an adequate bond between the panels.

In making a laminate panel, it may be helpful to be able to align the panels unless a random combination of channel lengths and volumes will provide suitable acoustical absorption. For example, it may be desirable to align the walls of the cores of two adjacent panels, or to align the through holes in first and second layer facing each other. In other cases, it may be desirable to ensure that the walls and/or through holes are not aligned.

### Examples

These examples are merely for illustrative purposes only and are not meant to be limiting on the scope of the appended claims. All parts, percentages, ratios, etc. in the examples and the rest of the specification are by weight, unless noted otherwise. The following abbreviations are used here: m/min=meters per minute; mm=millimeters; cm=centimeters; μm=micrometers; m=meters.

Acoustic panels were prepared using various methods as described below.

### Preparatory Example, Honeycomb

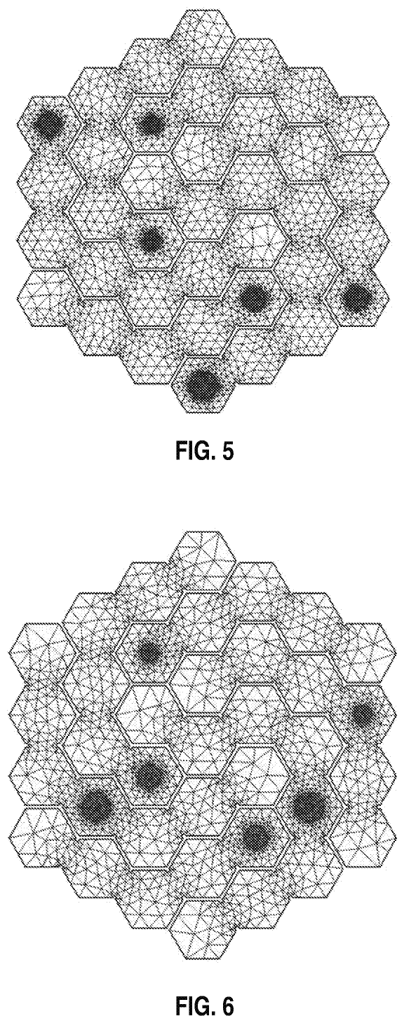

A flat polypropylene (PP) honeycomb panel was prepared according to Example 10 of published application WO2018034949 prior any thermoforming. The honeycomb panel had a 0.5 mm thick PP top skin and bottom skin, and a core with 11.5 mm hexagonal cells and interconnecting passageways connecting cells into series of cells having between 5 and 8 cells per series. Holes were drilled into one of the skins in the same pattern as in the Example (Example 10 of WO2018034949). The prepared panel is referred to as AAH-1 here. The positioning and size of holes are shown in TABLE 1 and in FIG. 5.

TABLE 1
Hole Positioning and Size in AAH-1.

| Series | Hole size and position |
|---|---|
| 5-cell (upper right) | 3 mm hole in end cell |
| 5-cell (lower left) | 4 mm hole in end cell |
| 6-cell (upper left) | 3 mm hole in end cell |
| 6-cell (right side) | 4 mm hole in end cell |
| 7-cell (left side) | 4 mm hole in end cell |
| 8-cell (lower right) | 5 mm hole in end cell |

Another panel was prepared using the same method (Example 10 of WO2018034949) but holes were drilled at different locations and were of different sizes. The panel is referred to as AAH-2. The positioning and size of holes are shown in TABLE 2 and in FIG. 6. The outer dimensions of both panels cut to were 17¼ inch×29 inch (44 cm×74 cm).

TABLE 2
Hole Positioning and Size in AAH-2.

| Series | Hole size and position |
|---|---|
| 5-cell (upper right) | 3 mm hole in end cell |
| 5-cell (lower left) | 4 mm hole in end cell |
| 6-cell (upper left) | 4 mm hole in end cell |
| 6-cell (right side) | 4 mm hole in one of the middle 2 cells |
| 7-cell (left side) | 5 mm hole in center cell |
| 8-cell (lower right) | 5 mm hole in one of the middle 2 cells |

The prepared panels AAH-1 and AAH-2 were used to prepare Samples 1 and 2, respectively, using an example server rack with an example server inside. A small 12 U (19″×31″×23.45″) server rack with closed sides (RackSolutions.com, Greenville, Tex.) was outfitted with two, 2 U servers (Hewlett Packard). Equipment for racks typically has a height that is a multiple of a rack unit, abbreviated as “U”. The height of one rack unit (e.g., U) is 1.75 inches (44.5 mm). Equipment for racks may have a height of, for example, 1 U, 2 U, 3 U, or 4 U. The servers were secured at the 2 U and 9 U positions as measured from the bottom of the rack using fixed rails. A set of 1 U rails was mounted at the 8 U position. On the front side of the rack, levels which did not contain either sample acoustic panel or servers, were outfitted with 1 U blanking panels (HOTLOK® 1 U panels, available from Racksolutions.com, Greenville, Tex.).

To test the sound absorption, the server lid was removed and the example acoustic panel was placed on top, holes down facing the interior of the server, and covering the entire open area. Vinyl tape was used to secure it to the server chassis and minimize air gaps.

### Test Methods

### Method 1: Insertion Loss with Internal Sound Source

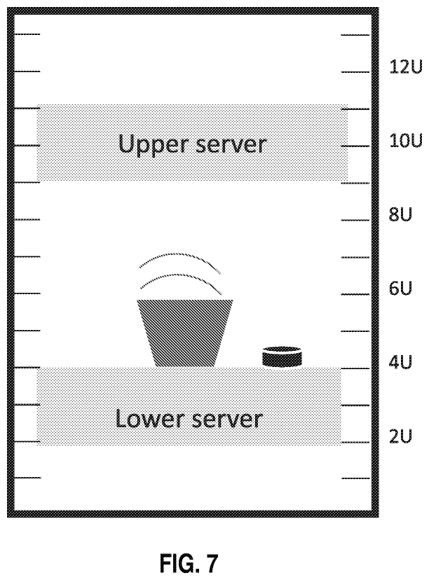

The effect of the acoustic panel on sound pressure levels was measured as follows. A 6 inch diameter Harmon Kardon model 320-001/01 speaker was attached to a foam support and then secured to the lid of the lower server. The purpose of the foam is to isolate the speaker mechanical vibrations from the server structure. A cross-section schematic is shown in FIG. 7.

To minimize the effect of background noise, the entire rack assembly was placed inside a small audiometric testing room, model CL-15A built by Eckel Noise Control Technologies. Calibrated multi-field ¼ inch microphones, type 4961 (Bruel & Kjaer, Denmark) were placed in various locations inside the rack: (1) on a foam block next to the speaker; (2) inside the fan cavity of the upper server and the lid closed. Microphone data was collected and analyzed using a Brüel & Kjaer Type 3160-A-042 data acquisition system and the associated Brüel & Kjaer Pulse LabShop software. The fan cavity is immediately adjacent to the hard disk drive arrays in these servers. This position is expected to be a good proxy for the sound pressure levels inside the hard disk drives themselves. In all cases foam supports were used with each microphone to minimize vibrational coupling between the microphone and the surrounding structures. Note that the computer servers were off during these measurements and served only as mass to represent the geometry and sound paths within a sample electronics rack. Pink noise (also known as 1/f noise) was emitted from the speaker in the range of 10 Hz-20 kHz and the sound pressure level vs. frequency measured at locations (1) and (2). The difference in the measured sound pressure level with the original metal server lid vs. the acoustic panel is referred to as the insertion loss.

### Method 2: Insertion Loss with External Sound Source

The insertion loss with a sound source external to the rack was measured using the same equipment and set up as described above. The only difference was that the speaker was removed from the rack and set on a mount inside the acoustic testing room but outside the rack.

### Results

Table 3 shows the relative sound pressure in each ⅓ octave band (“⅓ OB”) using the acoustic absorber panel compared to the same experiment using the original metal server lid, measured using Test Method 1. The difference in sound pressure level is reported as the insertion loss. Table 4 shows the same experiment measured using Test Method 2.

TABLE 3
Insertion Loss (dB) Measured Using Test Method 1.

| | Center | Microphone 1 | | Microphone 2 | |
|---|---|---|---|---|---|
| 1/3 OB | Freq. (Hz) | Sample 1 | Sample 2 | Sample 1 | Sample 2 |
| 1 | 20 | 0.4 | −1.2 | 0.9 | −0.6 |
| 2 | 25 | −0.7 | −0.5 | 0.6 | 0.2 |
| 3 | 32 | −1.1 | 0.2 | 0.4 | 0.2 |
| 4 | 40 | 0.2 | 0.5 | −0.9 | 1.9 |
| 5 | 50 | 0.4 | 0.0 | −2.6 | 1.8 |
| 6 | 63 | −0.4 | 0.9 | 0.3 | 0.9 |
| 7 | 80 | −0.1 | 0.6 | 0.2 | 0.0 |
| 8 | 100 | 0.2 | 0.0 | −0.6 | 0.3 |
| 9 | 125 | 0.1 | −0.1 | 0.1 | 0.2 |
| 10 | 160 | 0.2 | −0.2 | 0.8 | 0.5 |
| 11 | 200 | 0.3 | 0.2 | 0.9 | 0.6 |
| 12 | 250 | −1.5 | −1.1 | 0.7 | 0.3 |
| 13 | 315 | −0.7 | −0.3 | 0.0 | −1.3 |
| 14 | 400 | −0.5 | −0.5 | −4.1 | −0.9 |
| 15 | 500 | −0.1 | −0.1 | −2.3 | 1.6 |
| 16 | 630 | 0.9 | 0.4 | 0.5 | −0.7 |
| 17 | 800 | 0.0 | −0.1 | 1.6 | 0.8 |
| 18 | 1000 | −1.5 | −1.4 | −1.1 | 5.9 |
| 19 | 1250 | −0.4 | −0.3 | 0.3 | 4.9 |
| 20 | 1600 | −0.2 | −0.5 | −0.3 | 2.3 |
| 21 | 2000 | −0.1 | 0.5 | 2.7 | 3.9 |
| 22 | 2500 | 0.5 | 1.7 | 1.4 | 1.7 |
| 23 | 3150 | −0.3 | −0.4 | 2.7 | 3.1 |
| 24 | 4000 | 0.2 | 0.1 | −1.5 | 0.3 |
| 25 | 5000 | 0.1 | 0.3 | 1.2 | 3.2 |
| 26 | 6300 | 0.2 | 0.2 | −1.5 | −0.3 |
| 27 | 8000 | 0.0 | 0.4 | −1.4 | −0.4 |
| 28 | 10000 | 0.0 | 0.3 | −3.8 | −0.8 |
| 29 | 12500 | 0.3 | 0.2 | −0.5 | 0.4 |
| 30 | 16000 | 0.2 | 0.0 | 0.1 | 0.3 |
| 31 | 20000 | −0.6 | −0.2 | −1.1 | −0.5 |

TABLE 4
Insertion Loss (dB) Measured Using Test Method 2.

| | Center | Microphone 1 | | Microphone 2 | |
|---|---|---|---|---|---|
| 1/3 OB | Freq. (Hz) | Sample 1 | Sample 2 | Sample 1 | Sample 2 |
| 1 | 20 | −1.5 | 0.7 | −1.4 | 0.9 |
| 2 | 25 | 0.6 | 0.8 | 0.4 | 0.4 |
| 3 | 32 | 0.6 | 1.3 | 1.0 | 1.4 |
| 4 | 40 | −0.1 | −1.0 | 1.2 | 2.1 |
| 5 | 50 | −0.4 | −0.3 | −1.4 | 0.8 |
| 6 | 63 | −0.7 | −1.1 | −0.4 | −1.2 |
| 7 | 80 | 0.2 | 0.4 | 0.6 | 0.3 |
| 8 | 100 | −0.6 | −0.4 | −0.4 | −0.2 |
| 9 | 125 | −0.6 | −0.4 | −0.1 | −0.3 |
| 10 | 160 | 0.3 | −0.1 | 0.4 | −0.1 |
| 11 | 200 | −0.2 | −0.3 | 1.6 | 1.2 |
| 12 | 250 | −0.7 | −0.6 | 0.5 | 0.4 |
| 13 | 315 | −0.4 | −0.4 | −0.2 | −0.4 |
| 14 | 400 | 0.6 | 1.1 | −1.8 | −2.5 |
| 15 | 500 | 0.1 | −0.1 | 4.6 | 3.2 |
| 16 | 630 | 2.0 | 0.7 | −3.0 | −2.2 |
| 17 | 800 | −0.2 | −0.5 | −0.8 | −0.5 |
| 18 | 1000 | 0.9 | 0.7 | 1.6 | 5.5 |
| 19 | 1250 | 0.1 | 0.2 | 3.2 | 5.3 |
| 20 | 1600 | 2.7 | 1.8 | −3.3 | −3.9 |
| 21 | 2000 | −1.2 | 2.1 | −1.8 | −1.8 |
| 22 | 2500 | −1.3 | −0.2 | −0.1 | 0.9 |
| 23 | 3150 | 0.2 | 0.0 | 0.9 | 1.1 |
| 24 | 4000 | 0.1 | 0.1 | 1.8 | −1.6 |
| 25 | 5000 | 0.2 | 0.1 | 0.3 | 0.2 |
| 26 | 6300 | 0.9 | 0.7 | 0.1 | −0.6 |
| 27 | 8000 | 0.1 | 0.3 | 0.0 | −0.5 |
| 28 | 10000 | 0.3 | −0.1 | 0.1 | −0.2 |
| 29 | 12500 | 0.4 | 0.0 | 0.2 | 0.0 |
| 30 | 16000 | 0.1 | 0.1 | 0.0 | −0.1 |
| 31 | 20000 | 0.1 | 0.0 | 0.0 | −0.3 |

It was observed that Sample 2, which was designed for high frequency sound absorption, showed large insertion loss for the 1000 and 1250 Hz ⅓ octave bands that travels into the server cavity as measured on microphone 2. The acoustic panel worked in this frequency range using both test methods.

All references and publications cited herein are expressly incorporated herein by reference in their entirety into this disclosure, except to the extent they may directly contradict this disclosure. Although specific embodiments have been illustrated and described herein, it will be appreciated by those of ordinary skill in the art that a variety of alternate and/or equivalent implementations can be substituted for the specific embodiments shown and described without departing from the scope of the present disclosure. It should be understood that this disclosure is not intended to be unduly limited by the illustrative embodiments and examples set forth herein and that such examples and embodiments are presented by way of example only with the scope of the disclosure intended to be limited only by the claims set forth here.

1. An acoustic absorbing panel comprising:
a first layer and an opposing second layer, and
a core disposed between the first and second layers, the core comprising walls extending between the first layer and the second layer and defining a series of cells, each cell being at least partially surrounded by a wall, adjacent cells of the series of cells being interconnected via an opening in the at least one wall.

2. The acoustic absorbing panel of claim 1, wherein the walls extend from an inner surface of the first layer to an inner surface of the second layer.

3. The acoustic absorbing panel of claim 1 further comprising a through hole in the first layer or the second layer.

4. The acoustic absorbing panel of claim 3, wherein the through hole is aligned with a cell in a series of cells.

5. The acoustic absorbing panel of claim 3, wherein the series of cells comprises a first cell and a last cell and optionally one or more intermediate cells between the first and the last cells, and wherein the through hole is aligned with either the first cell or the last cell.

6. The acoustic absorbing panel of claim 1, wherein the core comprises a plurality of series of cells, and wherein adjacent series of cells are not interconnected via openings in the walls.

7. The acoustic absorbing panel of claim 1 further comprising a plurality of through holes in the first layer or the second layer, wherein each of the plurality of through holes is aligned with a cell in one of the series of cells.

8. The acoustic absorbing panel of claim 1 further comprising a plurality of through holes in the first layer or the second layer, wherein each series of cells is aligned with only a single through hole.

9. The acoustic absorbing panel of claim 1, wherein each wall defining a cell has a first area, and the opening has a second area, and wherein the second area is at least 50% of the first area.

10. The acoustic absorbing panel of claim 1 having an absorption band at a frequency between 800 Hz and 12000 Hz.

11. The acoustic absorbing panel of claim 1 having an absorption band at a frequency between 2000 Hz and 10000 Hz and a thickness from 3 mm to 10 mm.

12. The acoustic absorbing panel of claim 1, wherein at least one of the first or second layers comprises metal.

13. The acoustic absorbing panel of claim 1, wherein the first layer, the second layer, the core, or a combination thereof comprises a flame resistant polymer composition.

14. An electronics enclosure comprising:
a frame constructed to house electronics components;
an acoustic absorbing panel mounted on the frame, the panel comprising:
a first layer and an opposing second layer, and
a core disposed between the first and second layers, the core comprising walls extending between the first layer and the second layer and defining a series of cells, each cell being at least partially surrounded by a wall, adjacent cells of the series of cells being interconnected via an opening in the at least one wall.

15. The electronics enclosure of claim 14 further comprising a through hole in the first layer or the second layer.

16. The electronics enclosure of claim 15, wherein the through hole is aligned with a cell in a series of cells.

17. The electronics enclosure of claim 15, wherein the panel is mounted on a side of the frame with the first layer facing an interior space defined by the frame, and wherein the through hole is on the first layer.

18. The electronics enclosure of claim 15, wherein the series of cells comprises a first cell and a last cell and optionally one or more intermediate cells between the first and the last cells, and wherein the through hole is aligned with either the first cell or the last cell.

19. The electronics enclosure of claim 14, wherein the core comprises a plurality of series of cells, and wherein adjacent series of cells are not interconnected via openings in the walls.

20. The electronics enclosure of claim 14 further comprising a plurality of through holes in the first layer or the second layer, wherein each of the plurality of through holes is aligned with a cell in one of the series of cells.

21-28. (canceled)
